(19) United States
(12) Patent Application Publication
(10) Pub. No.: US 2023/0391905 A1
(43) Pub. Date: Dec. 7, 2023

(54) CURABLE RESIN, CURABLE RESIN COMPOSITION, AND CURED PRODUCT

(71) Applicant: DIC Corporation, Tokyo (JP)

(72) Inventors: Ryuichi MATSUOKA, Chiba (JP); Lichen YANG, Chiba (JP); Hiroyoshi KANNARI, Chiba (JP)

(73) Assignee: DIC Corporation, Tokyo (JP)

(21) Appl. No.: 18/267,768

(22) PCT Filed: Nov. 18, 2021
(86) PCT No.: PCT/JP2021/042358

§ 371 Date: Jun. 15, 2023

(30) Foreign Application Priority Data
Dec. 22, 2020 (JP) 2020-212622

(51) Int. Cl. C08F 136/22

(52) U.S. Cl. CPC C08F 136/22

(57) ABSTRACT

An object is to provide a cured product superior in heat resistance (high glass transition temperature) and dielectric properties (low dielectric properties) by using a curable resin having a specific structure and superior in storage stability. Specifically, a curable resin represented by general formula (1) below and having a hydroxyl group concentration of 0.005 to 3800 mmol/kg is provided.

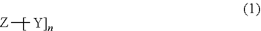

### TECHNICAL FIELD

The present invention relates to a curable resin having a specific structure, a curable resin composition containing the curable resin, and a cured product obtained using the curable resin composition.

### BACKGROUND ART

The increase in the volume of communicated information in recent years has made information communication in high-frequency bands popular. Against this background, there is a need for electrically insulating materials having a low dielectric constant and a low dielectric loss tangent for achieving better electrical properties, a reduced transmission loss in high-frequency bands in particular.

Since printed circuit boards or electronic components made with such electrically insulating materials are exposed to high-temperature solder reflow during mounting, furthermore, there is a need for materials that exhibit a high glass transition temperature, which are superior in heat resistance. More recently, a demand has been growing for electrically insulating materials with higher heat resistance in particular, because lead-free solder, which has a high melting point, is used in light of environmental issues.

To meet these demands, vinyl-containing curable resins having various chemical structures have been proposed. Examples of proposed ones of such curable resins include curable resins such as divinylbenzyl ethers of bisphenols and polyvinylbenzyl ethers of novolacs (see, for example, PTL 1 and 2). These vinylbenzyl ethers, however, fail to give a cured product with sufficiently small dielectric properties, and the resulting cured product is unacceptable for stable use in high-frequency bands. Divinylbenzyl ethers of bisphenols, furthermore, do not have sufficiently high heat resistance either.

In attempts to improve dielectric properties, for example, of these vinylbenzyl ethers with improved characteristics, some polyvinylbenzyl ethers in a specific structure have been proposed (see, for example, PTL 3 to 9). Attempts to reduce the dielectric loss tangent and attempts to improve heat resistance have been made, but improvements in these characteristics have yet to be sufficient; there is a desire for further improvements in characteristics.

As can be seen from these, the known vinyl-containing curable resins, including polyvinylbenzyl ethers, are not ones that give a cured product combining a low dielectric loss tangent required for use as an electrically insulating material, for use as an electrically insulating material supporting high frequencies in particular, and heat resistance enough to withstand lead-free soldering.

These vinyl-containing curable resins, furthermore, has a drawback of being inferior in storage stability because the vinyl groups react during storage. The improvement of this drawback has been awaited.

### CITATION LIST

### Patent Literature

PTL 1: Japanese Unexamined Patent Application Publication No. 63-68537
PTL 2: Japanese Unexamined Patent Application Publication No. 64-65110
PTL 3: Japanese Unexamined Patent Application Publication (Translation of PCT Application) No. 1-503238
PTL 4: Japanese Unexamined Patent Application Publication No. 5-43623
PTL 5: Japanese Unexamined Patent Application Publication No. 9-31006
PTL 6: Japanese Unexamined Patent Application Publication No. 2005-281618
PTL 7: Japanese Unexamined Patent Application Publication No. 2005-314556
PTL 8: Japanese Unexamined Patent Application Publication No. 2015-030776
PTL 9: Japanese Unexamined Patent Application Publication No. 2015-189925

### SUMMARY OF INVENTION

### Technical Problem

A problem to be solved by the present invention, therefore, lies in providing a curable resin superior in storage stability and contributable to heat resistance (high glass transition temperature) and dielectric properties (low dielectric properties) and providing a cured product superior in heat resistance (high glass transition temperature) and dielectric properties (low dielectric properties) by using the curable resin.

### Solution to Problem

After extensive research to solve the above problem, the inventors found a curable resin superior in storage stability and contributable to heat resistance and low dielectric properties and that a cured product obtained from a curable resin composition containing the curable resin is superior in heat resistance and low dielectric properties. These findings led the inventors to complete the present invention.

That is, the present invention relates to a curable resin represented by general formula (1) below, wherein a hydroxyl group concentration is from 0.005 to 3800 mmol/kg.

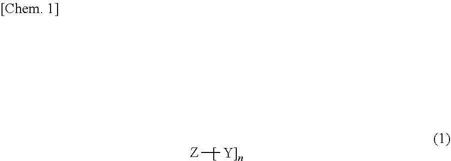

(In formula (1), Z is a C2 to C15 hydrocarbon, Y is a substituent represented by general formula (2) below, and n denotes an integer of 3 to 5, and

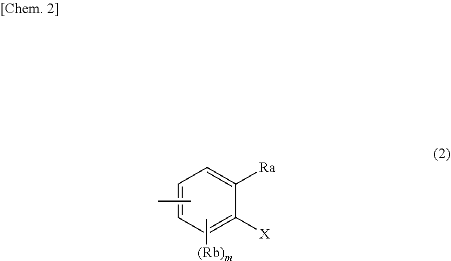

in formula (2), Ra and Rb each independently represent alkyl, aryl, aralkyl, or cycloalkyl group having C12 or less, m denotes an integer of 0 to 3, and X represents a hydroxyl, (meth)acryloyloxy, vinylbenzyl ether, or allyl ether group.)

For the curable resin according to the present invention, it is preferred that the hydroxyl group concentration be from 0.01 to 1500 mmol/kg.

For the curable resin according to the present invention, it is preferred that the X be a methacryloyloxy group.

For the curable resin according to the present invention, it is preferred that the Z be an aliphatic hydrocarbon.

The present invention relates to a curable resin composition containing the above curable resin.

The present invention relates to a cured product obtained through a curing reaction of the above curable resin composition.

### Advantageous Effects of Invention

The curable resin according to the present invention is one having a specific structure and superior in storage stability and is contributable to heat resistance and low dielectric properties. A cured product obtained using a curable resin composition containing the curable resin, therefore, is superior in heat resistance and low dielectric properties and is useful.

### BRIEF DESCRIPTION OF DRAWINGS

FIG. 1 is a ¹H-NMR spectrum of a curable resin obtained in Example 1.

FIG. 2 is a ¹H-NMR spectrum of a curable resin obtained in Example 9.

FIG. 3 is a ¹H-NMR spectrum of a curable resin obtained in Example 10.

### DESCRIPTION OF EMBODIMENTS

The present invention will now be described in detail.

### <Curable Resin>

The present invention relates to a curable resin represented by general formula (1) below. The hydroxyl group concentration is from 0.005 to 3800 mmol/kg.

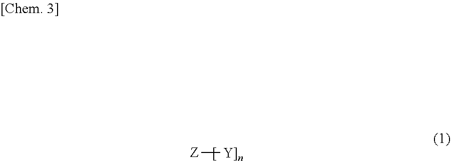

In general formula (1) above, Z is a C2 to C15 hydrocarbon, Y is a substituent represented by general formula (2) below, and n denotes an integer of 3 to 5.

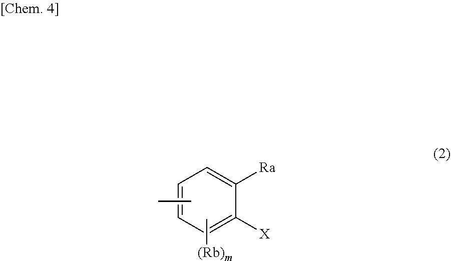

In general formula (2) above, furthermore, Ra and Rb each independently represent alkyl, aryl, aralkyl, or cycloalkyl group having a C12 or less, m denotes an integer of 0 to 3, and X represents a hydroxyl, (meth)acryloyloxy, vinylbenzyl ether, or allyl ether group.

The curable resin contains multiple Xs that can function as crosslinking groups (crosslinking groups (X)). A cured product obtained by crosslinking the curable resin, therefore, has a high crosslink density and is superior in heat resistance. The crosslinking groups, furthermore, are also polar groups, but the presence of the substituents (Ra in particular) adjacent to the crosslinking groups keeps the molecular mobility of the crosslinking groups low, allowing the resulting cured product to achieve low dielectric properties (a low dielectric loss tangent in particular). This is preferred.

The above X that can function as a crosslinking group refers to a functional group that directly contributes to a crosslinking reaction (self-crosslinking) or polymerization reaction, such as a (meth)acryloyloxy group or other vinyl group containing an unsaturated double bond. It should be noted that the hydroxyl group included in the Xs functions as a polymerization inhibitor in the present invention but is also contributable to reaction, for example with an epoxy resin. The crosslinking groups described herein, therefore, include a hydroxyl group.

In general formula (1) above, Z is a C2 to C15 hydrocarbon, preferably a C2 to C10 hydrocarbon, more preferably a C2 to C6 hydrocarbon. A number of carbon atoms in these ranges is a preferred embodiment because it allows the curable resin to be a low-molecular-weight compound and achieve a high crosslink density compared with when it is a high-molecular-weight compound, and the resulting cured product to have a high glass transition temperature and be superior in heat resistance. When the number of carbon atoms is fewer than two, the resulting curable resin is too low-molecular-weight a compound, and the crosslink density of the cured product is too high. The cured product itself is thus brittle and tends to fail to form, for example, a film and be inferior in the ease of handling, bendability, flexibility, and resistance to brittle fracture. When the number of carbon atoms exceeds 15, furthermore, the resulting curable resin is a high-molecular-weight compound, and the percentage that the crosslinking groups (X) make up in the curable resin is low. The crosslink density is reduced accordingly, and the heat resistance of the resulting cured product is inferior. These cases are not preferred.

The hydrocarbon can be of any type as long as it is a C2 to C15 hydrocarbon, but preferably is, for example, an aliphatic hydrocarbon, such as an alkane, alkene, or alkyne. Examples include aromatic hydrocarbons containing an aryl or similar group and compounds that are combinations of an aliphatic hydrocarbon and an aromatic water carbide.

Among aliphatic hydrocarbons, examples of alkanes include ethane, propane, butane, pentane, hexane, and cyclohexane.

Examples of alkenes include ones containing a vinyl, 1-methylvinyl, propenyl, butenyl, butenyl, pentenyl, pentenyl, or similar group.

Examples of alkynes include ones containing an ethynyl, propynyl, butynyl, pentynyl, hexynyl, or similar group.

Examples of aromatic hydrocarbons include ones containing a phenyl, tolyl, xylyl, naphthyl, or similar group as an aryl group.

Examples of compounds that are combinations of an aliphatic hydrocarbon and an aromatic hydrocarbon include ones containing a benzyl, phenylethyl, phenylpropyl, tolylmethyl, tolylethyl, tolylpropyl, xylylmethyl, xylylethyl, xylylpropyl, naphthylmethyl, naphthylethyl, naphthylpropyl, or similar group.

Of these hydrocarbons, it is particularly preferred that the hydrocarbon be an aliphatic, aromatic, or alicyclic hydrocarbon consisting solely of carbon and hydrogen atoms because this allows a cured product of low polarity and having low dielectric properties (a low dielectric constant and a low dielectric loss tangent) to be obtained. In particular, such hydrocarbons as in general formulae (3-1) to (3-6) below, which are of very low polarity and industrially usable, are preferred, and the aliphatic hydrocarbons of general formula (3-1) below are more preferred because they are superior in low dielectric properties. It should be noted that in general formula (3-1) below, k represents an integer of 0 to 5, preferably is from 0 to 3. The Rc or Rcs in general formulae (3-1), (3-2), and (3-4) to (3-6) below are preferably represented by a hydrogen atom or methyl group.

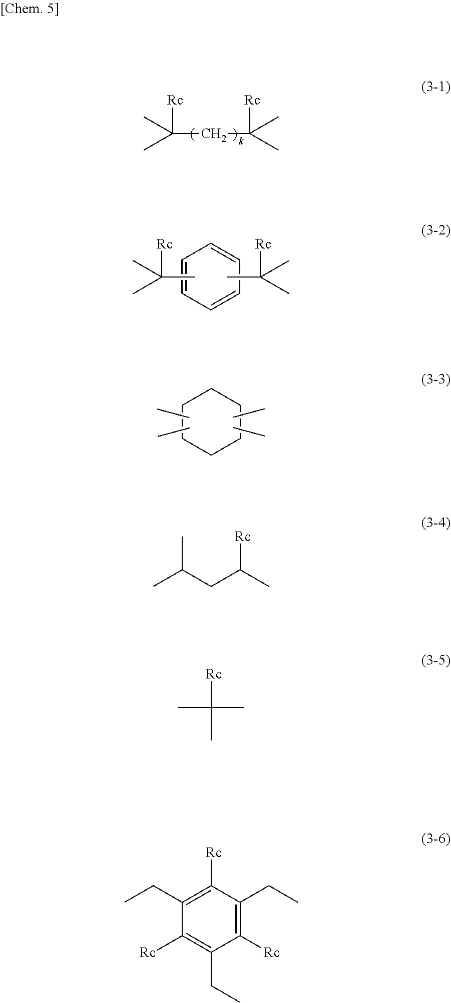

In general formula (1) above, the number-average molecular weight of Z (central structure) is preferably from 20 to 200. When the number-average molecular weight is less than 20, too high a crosslink density tends to cause brittleness. When the number-average molecular weight exceeds 200, heat resistance tends to be weak because of a low crosslink density.

In general formula (2) above, Ra and Rb each independently represent alkyl, aryl, aralkyl, or cycloalkyl group having a C12 or less. Preferably, each of Ra and Rb is independently a C1 to C4 alkyl, aryl, or cycloalkyl group. Ra and Rb being C1 to C12 alkyl or similar groups is a preferred embodiment because it reduces planarity in the vicinity of the benzene ring, and the reduced crystallinity improves solubility in solvents while lowering the melting point. The presence of Ra and Rb (Ra in particular, which is adjacent to the crosslinking group X), furthermore, is preferred because it presumably further reduces the molecular mobility of the crosslinking group (X) by creating steric hindrances, allowing a cured product with lower dielectric properties (a lower dielectric loss tangent in particular) to be obtained. Tert-butyl groups, however, would not be preferred because they would be likely to cause the production of isobutene gas as a result of thermal decomposition upon heating.

In general formula (2) above, m represents an integer of 0 to 3. Preferably, m is 0 or 1, more preferably 1. m in these ranges is a preferred embodiment because it allows the substituent Rb to create a steric hindrance that reduces the molecular mobility of the crosslinking group (X), leading to excellent low dielectric properties. It should be noted that when m is 0, Rb represents a hydrogen atom.

In general formula (1) above, n is the number of substituents and denotes an integer of 3 to 5. Preferably, n is 3 or 4, more preferably 4. n in these ranges is a preferred embodiment because it allows the curable resin to be a low-molecular-weight compound and achieve a high crosslink density compared with when it is a high-molecular-weight compound, and the resulting cured product to have a high glass transition temperature and be superior in heat resistance. It should be noted that when n is 2, there are few crosslinking groups. The crosslink density of the resulting cured product is low, and sufficient heat resistance is not obtained. When n is 6 or greater than it, on the other hand, the crosslink density of the cured product is too high. The cured product itself is thus brittle and tends to fail to form, for example, a film and be inferior in the ease of handling, bendability, flexibility, and resistance to brittle fracture. These cases are not preferred.

In general formula (2) above, X is a hydroxyl, (meth)acryloyloxy, vinylbenzyl ether, or allyl ether group that is to serve as a crosslinking group. Preferably, X is a (meth)acryloyloxy group, more preferably a methacryloyloxy group. The presence of the crosslinking groups in the curable resin is a preferred embodiment because it allows a cured product having a low dielectric loss tangent to be obtained.

Incidentally, the methacryloyloxy group is preferred because it allows, compared with other crosslinking groups (e.g., vinylbenzyl ether, allyl ether, and other ether groups that are polar groups), the curable resin to contain methyl groups in its structure. The resulting great steric hindrances, presumably, further reduce molecular mobility, and a cured product with a lower dielectric loss tangent is obtained. The presence of multiple crosslinking groups, furthermore, is preferred because it increases the crosslink density and improves heat resistance.

The crosslinking group X is also a polar group, but the presence of the substituents Ra and Rb (Ra in particular) adjacent to X limits the molecular mobility of X by creating steric hindrances and reduces the dielectric loss tangent of the resulting cured product. This leads to a preferred embodiment.

X being a hydroxyl group, furthermore, is useful because it allows radicals produced during the storage of the curable resin, for example by light, heat, or air, to become stable radicals by withdrawing the phenolic hydrogen in the hydroxyl group. In that case radical polymerization is prevented, and the hydroxyl group functions as a polymerization inhibitor. The storage stability of the curable resin is thus improved.

The curable resin according to the present invention is a mixture of curable resins having different combinations of crosslinking groups, substituents, etc., in their structure, which means, for example, that the curable resin contains curable resins such as a curable resin having, as a crosslinking group (X), a hydroxyl group, a curable resin having a functional group that directly contributes to a crosslinking or other reaction, such as a (meth)acryloyl group, and a curable resin having both hydroxyl and (meth)acryloyl groups.

It should be noted that the curable resin according to the present invention has a hydroxyl group concentration in a specific range. The curable resin that is a mixture, therefore, contains at least a curable resin having a hydroxyl group as a crosslinking group (X). The hydroxyl group functions as a polymerization inhibitor in the present invention, but when the curable resin is formulated with, for example, an epoxy resin to be cured, the hydroxyl group can function as a crosslinking group.

For the curable resin according to the present invention, furthermore, it is preferred that general formula (1) above be represented by general formula (1A) below. By virtue of general formula (1) above being narrowed down to the structure of general formula (1A) below, or when the structural formula presented in general formula (1A) above is compared with the structural formula presented in general formula (1) above, the position of Z is fixed (limited) with respect to Ra and X. A curable resin having a structure represented by such general formula (1A) above, furthermore, is a preferred embodiment because it has heightened reactivity of its crosslinking groups. Compared with a curable resin having a structure represented by general formula (1) above, therefore, the curable resin forms a dense crosslinked structure and thus is better in terms of resistance to thermal decomposition.

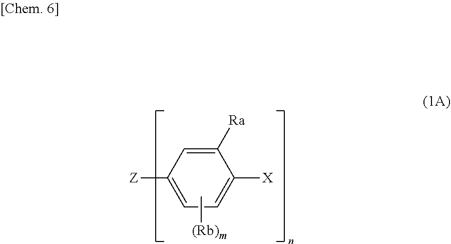

For the curable resin according to the present invention, it is preferred that n be 4. n in general formula (1A) above being 4 is a more preferred embodiment because it allows the curable resin to achieve a high crosslink density and, owing to not too many crosslinking groups, sufficient heat resistance to be achieved together with excellent ease of handling, bendability, flexibility, and resistance to brittle fracture.

For the curable resin according to the present invention, it is preferred that X be a methacryloyloxy group. X in general formula (1A) above being a methacryloyloxy group is a preferred embodiment because it allows a cured product having a low dielectric loss tangent to be obtained as a consequence of the presence of the crosslinking groups in the curable resin. Incidentally, the methacryloyloxy group is more preferred because it allows, compared with other crosslinking groups (e.g., vinylbenzyl ether, allyl ether, and other ether groups that are polar groups), the curable resin to contain methyl groups in its structure. The resulting great steric hindrances, presumably, further reduce molecular mobility, and a cured product with a lower dielectric loss tangent is obtained. The presence of multiple crosslinking groups, furthermore, is more preferred because in that case the crosslink density increases, and thus heat resistance improves. It should be noted that the curable resin according to the present invention has a hydroxyl group concentration in a specific range. As in formula (2) above, therefore, the curable resin contains a curable resin having a hydroxyl group as a crosslinking group (X).

For the curable resin according to the present invention, it is preferred that Z be an aliphatic hydrocarbon. Z in general formula (1A) above being an aliphatic hydrocarbon is a more preferred embodiment because the reduced polarity leads to low dielectric properties (a low dielectric constant and a low dielectric loss tangent).

In general formula (1A) above, Z is preferably a C2 to C15 aliphatic hydrocarbon, more preferably a C2 to C10 aliphatic hydrocarbon. When the number of carbon atoms is fewer than 2, too high a crosslink density causes brittleness, resulting in inferior resistance to brittle fracture. When the number of carbon atoms exceeds 15, heat resistance is inferior because of a low crosslink density. These cases are not preferred. Examples of aliphatic hydrocarbons are the same as the aliphatic hydrocarbons listed as examples for the hydrocarbon in general formula (1) above.

In general formula (1A) above, Ra, Rb, m, and n are synonymous with Ra, Rb, m, and n in general formulae (1) and (2) above.

It should be noted that general formula (1) above includes not only general formula (1A) above but also general formula (1B) below, but general formula (1A) above is more preferred because it has the crosslinking group X at a position favorable for reaction, allowing the curing reaction to proceed smoothly. A curable resin represented by general formula (1B) below, by contrast, may cause a lowered thermal decomposition temperature because it is likely to remain uncured in the curing reaction.

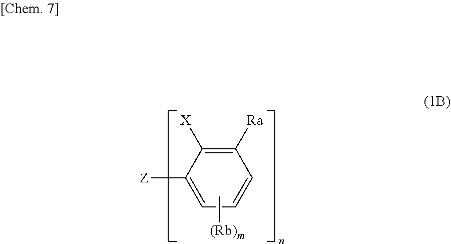

The curable resin according to the present invention has a hydroxyl group concentration of 0.005 to 3800 mmol/kg, preferably 0.008 to 3500 mmol/kg, more preferably 0.01 to 3000 mmol/kg, particularly preferably 0.01 to 1500 mmol/kg. A hydroxyl group concentration in these ranges is a preferred embodiment because it allows radicals produced during the storage of the curable resin or a curable resin composition containing the curable resin to become stable radicals by reacting with phenolic hydrogens. In that case the reaction of the crosslinking groups other than hydroxyl groups is inhibited, and the curable resin itself or the curable resin composition is superior in storage stability. When the hydroxyl group concentration is less than 0.005 mmol/kg, storage stability is insufficient. When the hydroxyl group concentration exceeds 3800 mmol/kg, the dielectric loss tangent and the dielectric constant become worse (increase) because the crosslink density based on crosslinking groups other than hydroxyl groups is insufficient and because the polarity based on hydroxyl groups is high. These cases are not preferred. It should be noted that the hydroxyl group concentration is a value calculated based on hydroxyl number measurement (a method according to JIS K 1557-1).

For the storage stability of the curable resin itself or the curable resin composition, a separate polymerization inhibitor may be used. The curable resin according to the present invention, however, has many crosslinking groups (n is from 3 to 5) and is multifunctional. Even when a polymerization inhibitor is used, therefore, it is difficult to achieve full storage stability effects. Increasing the amount of the polymerization inhibitor, furthermore, is not preferred because in that case storage stability admittedly improves, but the dielectric constant and the dielectric loss tangent increase.

### <Method for Producing an Intermediate Phenolic Compound>

As a method for producing the above curable resin, a method for producing an intermediate phenolic compound as a raw material for (precursor to) the curable resin will be described below first.

In this method for producing an intermediate phenolic compound, at least one aldehyde or ketone compound represented by general formulae (4) to (9) below is mixed with at least one phenol represented by general formulae (10) to (16) below or derivative thereof. Allowing the mixed compounds to react in the presence of an acid catalyst gives the intermediate phenolic compound. k, Ra, and Rb in general formulae (4) to (16) below are synonymous with k, Ra, and Rb in general formulae (2) and (3-1) above.

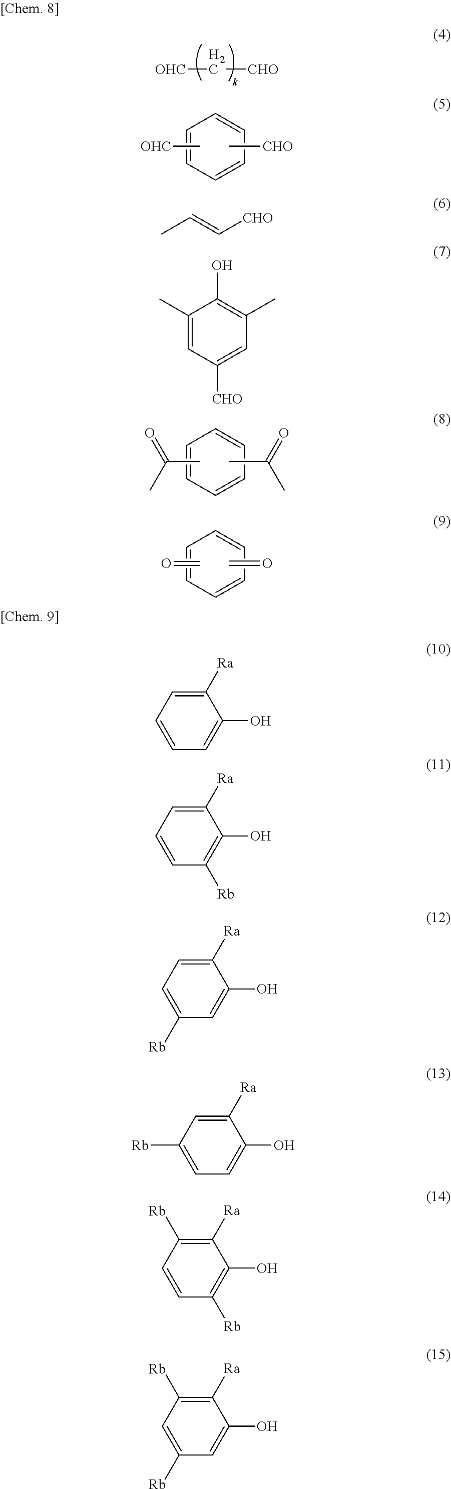

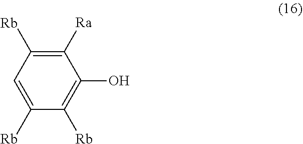

For the aldehyde or ketone compound (Hereinafter also referred to as “compound (a).”), specific examples of aldehyde compounds include formaldehyde, acetaldehyde, propionaldehyde, pivalaldehyde, butyraldehyde, pentanal, hexanal, trioxane, cyclohexylaldehyde, diphenylacetaldehyde, ethylbutyraldehyde, benzaldehyde, glyoxylic acid, 5-norbornene-2-carboxaldehyde, malondialdehyde, succindialdehyde, salicylaldehyde, naphthaldehyde, glyoxal, malondialdehyde, succinaldehyde, glutaraldehyde, crotonaldehyde, phthalaldehyde, and terephthalaldehyde. Of these aldehyde compounds, glyoxal, glutaraldehyde, crotonaldehyde, phthalaldehyde, and terephthalaldehyde, for example, are particularly preferred because they are industrially readily available. As for ketone compounds, cyclohexanedione and diacetylbenzene are preferred. In particular, cyclohexanedione is more preferred in that it is industrially readily available. For the use of compound (a), using one compound alone is not the only possible option; the use of two or more compounds in combination is also allowed.

The phenol or derivative thereof (Hereinafter also referred to as “compound (b).”) can be of any type, but specific examples include cresols, such as o-cresol, m-cresol, and p-cresol; phenol; xylenols, such as 2,3-xylenol, 2,4-xylenol, 2,5-xylenol, 2,6-xylenol (2,6-dimethylphenol), 3,4-xylenol, 3,5-xylenol, and 3,6-xylenol; alkylphenols, including ethylphenols, such as o-ethylphenol (2-ethylphenol), m-ethylphenol, and p-ethylphenol; isopropylphenol, butylphenols, such as butylphenol and p-t-butylphenol; and p-pentylphenol, p-octylphenol, p-nonylphenol, and p-cumylphenol; and o-phenylphenol (2-phenylphenol), p-phenylphenol, 2-cyclohexylphenol, 2-benzylphenol, 2,3,6-trimethylphenol, 2,3,5 trimethylphenol, 2-cyclohexyl-5-methylphenol, 2-t-butyl-5 methylphenol, 2-isopropyl-5-methylphenol, 2-methyl-5-isopropylphenol, 2,6-t-butylphenol, 2,6-diphenylphenol, 2,6-dicyclohexylphenol, 2,6-diisopropylphenol, 3-benzylbiphenyl-2-ol, 2,4-di-t-butylphenol, 2,4-diphenylphenol, and 2-t-butyl-4-methylphenol. These phenols or derivatives thereof may each be used alone, or two or more may be used in combination. In particular, using a compound alkylated at two of the ortho and para positions with respect to the phenolic hydroxyl group, such as 2,6-xylenol or 2,4-xylenol, is a more preferred embodiment. Too great a steric hindrance, however, may interfere with reactivity in the synthesis of the intermediate phenolic compound. It is, therefore, preferred to use a compound (b) or compounds (b) having, for example, a methyl, ethyl, isopropyl, cyclohexyl, or benzyl group.

In a method for producing the intermediate phenolic compound used in the present invention, compounds (a) and (b) as described above are put into a vessel, preferably with the molar ratio of compound (b) to compound (a) (compound (b)/compound (a)) being from 0.1 to 10, more preferably from 0.2 to 8. Then allowing the compounds to react in the presence of an acid catalyst gives the intermediate phenolic compound.

Examples of acid catalysts used for this reaction include inorganic acids, like phosphoric acid, hydrochloric acid, and sulfuric acid, organic acids, such as oxalic acid, benzenesulfonic acid, toluenesulfonic acid, methanesulfonic acid, and fluoromethanesulfonic acid, solid acids, like activated clay, montmorillonite clay, silica alumina, zeolite, and strongly acidic ion exchange resins, and heteropolyacid salts. It is, however, preferred to use any of inorganic acids, oxalic acid, benzenesulfonic acid, toluenesulfonic acid, methanesulfonic acid, and fluoromethanesulfonic acid, which are homogeneous catalysts and can be easily and conveniently removed by neutralization with a base and washing with water after the reaction.

As for the amount of the acid catalyst, 0.001 to 40 parts by mass of the acid catalyst is added to a total of 100 parts by mass of compounds (a) and (b) as the raw materials that are put into the vessel first. For the ease of handling and economy reasons, however, it is preferred that the amount of the acid catalyst be from 0.001 to 25 parts by mass.

In general, the temperature of the reaction only needs to be in the range of 30° C. to 150° C. To limit the formation of isomeric structures, avoid thermal decomposition and other side reactions, and thereby obtain a high-purity intermediate phenolic compound, however, it is preferred that the reaction temperature be from 60° C. to 120° C.

In general, the duration of the reaction is in the range of a total of 0.5 to 24 hours under the above reaction temperature conditions because the reaction does not completely proceed in a short duration and because a long duration causes side reactions, such as a thermal decomposition reaction of the product. Preferably, however, the duration of the reaction is in the range of a total of 0.5 to 15 hours.

In this method for producing an intermediate phenolic compound, the phenol or derivative thereof also serves as a solvent. Other solvents, therefore, do not necessarily need to be used, but the use of solvents is also allowed.

Examples of organic solvents used to synthesize the intermediate phenolic compound include ketones, such as acetone, methyl ethyl ketone (MEK), methyl isobutyl ketone, cyclohexanone, and acetophenone, alcohols, such as 2-ethoxyethanol, methanol, and isopropyl alcohol, aprotic solvents, such as N,N-dimethylformamide, N,N-dimethylacetamide, dimethylsulfoxide, N-methyl-2-pyrrolidone, acetonitrile, and sulfolane, cyclic ethers, such as dioxane and tetrahydrofuran, esters, such as ethyl acetate and butyl acetate, and aromatic solvents, such as benzene, toluene, and xylene. These may be used alone or may be used as a mixture.

The hydroxyl equivalent weight (phenol equivalent) of the intermediate phenolic compound is preferably from 80 to 500 g/eq, more preferably from 100 to 300 g/eq, for heat resistance reasons. It should be noted that the hydroxyl equivalent weight (phenol equivalent) of the intermediate phenolic compound is that calculated by titration. The titration refers to neutralization titration according to JIS K0070.

### <Method for Producing the Curable Resin>

A method for producing the above curable resin (the introduction of a (meth)acryloyloxy, vinylbenzyl ether, or allyl ether group into the intermediate phenolic compound) will now be described.

The curable resin can be obtained by known methods, such as allowing, for example, a (meth)acrylic anhydride, (meth)acrylic acid chloride, chloromethylstyrene, chlorostyrene, allyl chloride, or allyl bromide (hereinafter also referred to as “(meth)acrylic anhydride or such like”) to react with the intermediate phenolic compound in the presence of a basic or acidic catalyst. Allowing them to react is a preferred embodiment because it introduces crosslinking groups (X) into the intermediate phenolic compound and results in a cured product with a low dielectric constant and a low dielectric loss tangent.

Examples of (meth)acrylic anhydrides include acrylic anhydride and methacrylic anhydride. Examples of (meth)acrylic acid chlorides include methacrylic acid chloride and acrylic acid chloride. Examples of chloromethylstyrenes, furthermore, include p-chloromethylstyrene and m-chloromethylstyrene, examples of chlorostyrenes include p-chlorostyrene and m-chlorostyrene, an example of an allyl chloride is 3-chloro-1-propene, and an example of an allyl bromide is 3-bromo-1-propene. These may each be used alone or may be used as a mixture. In particular, it is preferred to use methacrylic anhydride or methacrylic acid chloride, with which a cured product with a lower dielectric loss tangent is obtained.

Specific examples of basic catalysts include dimethylaminopyridine, alkaline earth metal hydroxides, alkali metal carbonates, and alkali metal hydroxides. Specific examples of acidic catalysts include sulfuric acid and methanesulfonic acid. In particular, dimethylaminopyridine is superior in terms of catalytic activity.

For the reaction between the intermediate phenolic compound and the (meth)acrylic anhydride or such like, an example of a method is to add 1 to 10 moles of the (meth)acrylic anhydride or such like, per mole of hydroxyl groups in the intermediate phenolic compound, and allowing the compounds to react at a temperature of 30° C. to 150° C. for 1 to 40 hours while adding 0.01 to 0.2 moles of a basic catalyst all at once or gradually.

By using an organic solvent during the reaction with the (meth)acrylic anhydride or such like (introduction of crosslinking groups), furthermore, the reaction rate in the synthesis of the curable resin can be increased. Such an organic solvent can be of any type, but examples include ketones, such as acetone and methyl ethyl ketone, alcohols, such as methanol, ethanol, 1-propyl alcohol, isopropyl alcohol, 1-butanol, secondary butanol, and tertiary butanol, cellosolves, such as methyl cellosolve and ethyl cellosolve, ethers, such as tetrahydrofuran, 1,4-dioxane, 1,3-dioxane, and diethoxyethane, aprotic polar solvents, such as acetonitrile, dimethylsulfoxide, and dimethylformamide, and toluene. These organic solvents may each be used alone, or, optionally, two or more may be used in combination to adjust polarity.

After the end of the reaction with the (meth)acrylic anhydride or such like (introduction of crosslinking groups) described above, the reaction product is reprecipitated in a poor solvent, and then the precipitate is stirred in the poor solvent at a temperature of 20° C. to 100° C. for 0.1 to 5 hours. Filtering the mixture under reduced pressure and then drying the precipitate at a temperature of 40° C. to 80° C. for 1 to 10 hours gives the desired curable resin. An example of a poor solvent is hexane.

The softening point of the curable resin is preferably 150° C. or below, more preferably from 20° C. to 140° C. A softening point of the curable resin in these ranges is preferred because it makes the curable resin superior in workability.

### <Curable Resin Composition>

The present invention relates to a curable resin composition containing the above curable resin. Since the above curable resin is contributable to heat resistance and low dielectric properties (a low dielectric loss tangent in particular), a cured product obtained using a curable resin composition containing the curable resin is superior in heat resistance and low dielectric properties and is a preferred embodiment.

### [Extra Resins and Other Ingredients]

In the curable resin composition according to the present invention, extra resins, a curing agent, a curing accelerator, etc., can be used without particular limitations besides the curable resin, unless any object of the present invention is impaired. As will be described later, the curable resin gives a cured product, for example when heated, without being formulated with a curing agent. If extra resins, for example, are also added, however, an ingredient such as a curing agent or curing accelerator may be added and used.

It should be noted that the curable resin composition according to the present invention contains the above curable resin. Of curable resins as described above, however, curable resins for which X is an allyl ether group cannot be homopolymerized (crosslinked) (cannot give a cured product by themselves), unlike those for which X is a (meth)acryloyloxy or vinylbenzyl ether group. If X is an allyl ether group, therefore, it is needed to use an ingredient such as a curing agent or curing accelerator.

### [Extra Resins]

For extra resins, compounds such as alkenyl-containing compounds, including bismaleimides, allyl ether compounds, allylamine compounds, triallyl cyanurate, alkenyl phenol compounds, and vinyl-containing polyolefin compounds, can also be added. Optionally, other thermosetting resins, such as thermosetting polyimide resins, epoxy resins, phenolic resins, active ester resins, benzoxazine resins, and cyanate resins, can also be contained according to purposes.

### [Curing Agent]

Examples of curing agents include amine compounds, amide compounds, acid anhydride compounds, phenolic compounds, and cyanate ester compounds. These curing agents may be used alone, or two or more of them may be used in combination.

### [Curing Accelerator]

Various types of curing accelerators can be used, but examples include phosphorus compounds, tertiary amines, imidazoles, metal salts of organic acids, Lewis acids, and amine complex salts. For use in semiconductor encapsulant applications in particular, phosphorus compounds, such as triphenylphosphine, or imidazoles are preferred in that they lead to excellent curability, heat resistance, electrical properties, moisture reliability, etc. These curing accelerators can be used alone, or two or more of them can be used in combination.

### [Flame Retardant]

When necessary, the curable resin composition according to the present invention can be formulated with a flame retardant so that flame retardancy will be produced. In particular, it is preferred to add a non-halogen flame retardant, which contains substantially no halogen atom. Examples of non-halogen flame retardants include phosphorus flame retardants, nitrogen flame retardants, silicone flame retardants, inorganic flame retardants, and organometallic salt flame retardants. These flame retardants may be used alone, or two or more may be used in combination.

### [Filler]

When necessary, the curable resin composition according to the present invention can be formulated with an inorganic substance filler. Examples of inorganic substance fillers include fused silica, crystalline silica, alumina, silicon nitride, and aluminum hydroxide. When the amount of the inorganic filler is set especially high, it is preferred to use fused silica. The fused silica can be used in crushed or bead form, but to increase the amount of fused silica with a limited increase in the melt viscosity of the material to be shaped, it is preferred to primarily use a bead form. To further increase the amount of silica beads, it is preferred to adjust the particle size distribution of the silica beads appropriately. When the curable resin composition is used in applications such as electrically conductive paste, which will be described in detail later, electrically conductive fillers, such as a silver powder and a copper powder, can be used.

### [Other Additives]

When necessary, various additives, such as a silane coupling agent, a release agent, a pigment, and an emulsifier, can be added to the curable resin composition according to the present invention.

### <Cured Product>

The present invention relates to a cured product obtained through a curing reaction of the above curable resin composition. The curable resin composition is obtained by mixing the above curable resin alone or the curable resin with ingredients described above, such as a curing agent, until uniformity, and can be easily made into a cured product by a method similar to known methods in the related art. Examples of cured products include shaped cured articles, such as a multilayer article, a cast article, an adhesive layer, a coating, and a film.

Examples of curing reactions include thermal curing and ultraviolet curing reactions. In particular, thermal curing reaction is easy to carry out even without a catalyst, but when there is a demand for a faster reaction, it is effective to add a polymerization initiator, like an organic peroxide or azo compound, and a basic catalyst, like a phosphine compound or tertiary amine. Examples include benzoyl peroxide, dicumyl peroxide, azobisisobutyronitrile, triphenylphosphine, triethylamine, and imidazoles.

### <Applications>

Since a cured product obtained using the curable resin composition according to the present invention is superior in heat resistance and dielectric properties, suitable applications include heat-resistant components and electronic components. Particularly suitable applications include, for example, prepregs, circuit boards, semiconductor encapsulants, semiconductor devices, build-up films, build-up substrates, adhesives, and resist materials. A matrix resin in fiber-reinforced plastics is also a suitable application, and a particularly suitable application is highly heat-resistant prepregs. The curable resin contained in the curable resin composition, furthermore, can be made into paint because it exhibits excellent solubility in various solvents. Heat-resistant components and electronic components obtained in such a manner are suitable for use in various applications. Examples include, but are not limited to, components for industrial machinery, components for general-purpose machinery, components for automobiles, railways, vehicles, etc., astronautical and aeronautical components, electronic and electric components, building materials, container and packaging elements, household goods, sporting and leisure goods, and enclosure elements for wind power generation.

### EXAMPLES

The present invention will now be described more specifically by examples and comparative examples, where “parts” and “%” are by mass unless stated otherwise. It should be noted that curable resins and cured products obtained using curable resin compositions containing the curable resins were synthesized under the conditions set forth below, and the resulting cured products were subjected to measurement and evaluation under the conditions below.

### <¹H-NMR Measurement>

¹H-NMR: JEOL RESONANCE's “JNM-ECA600”
Magnetic field strength: 600 MHZ
The number of scans: 32
Solvent: CDCl₃
Sample concentration: 1% by mass

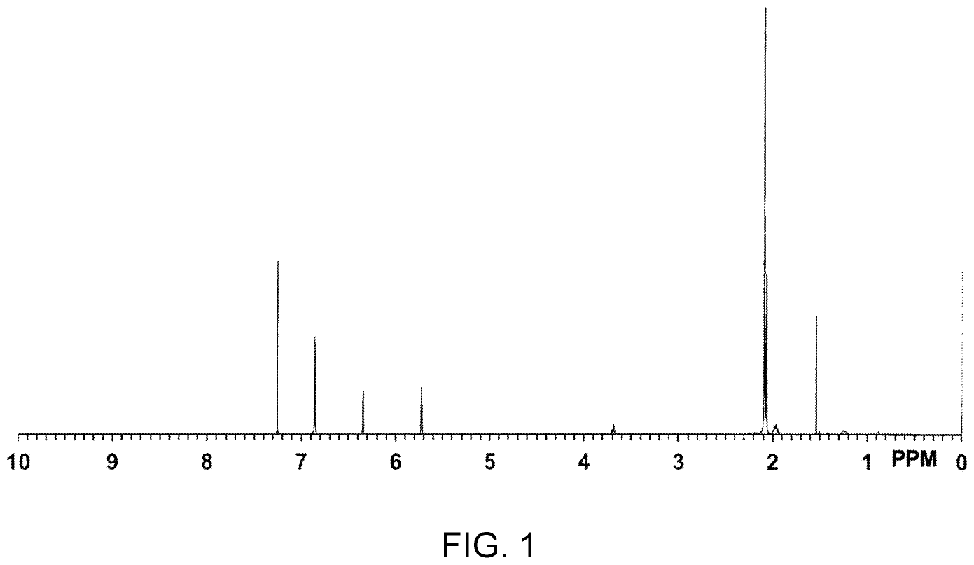

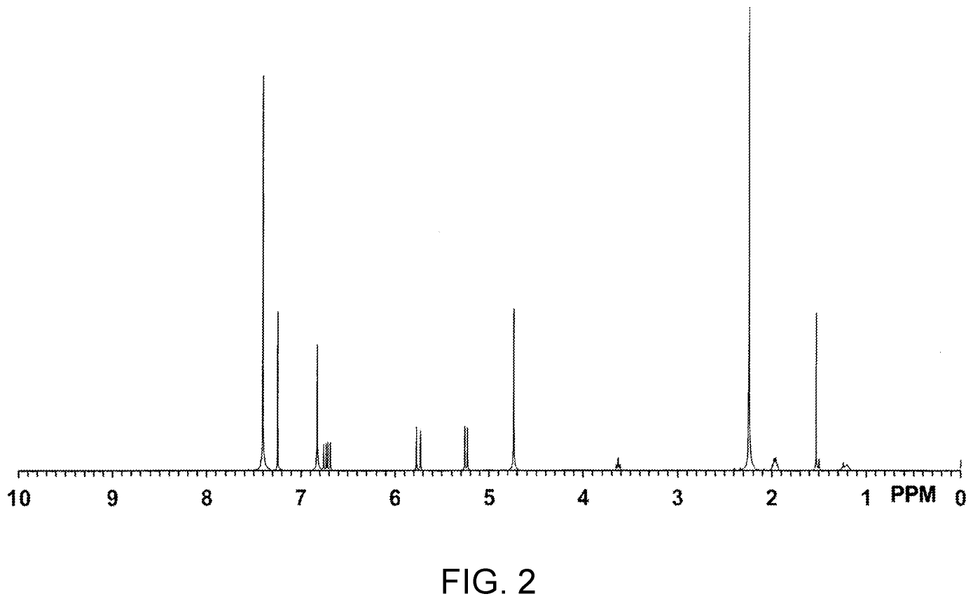

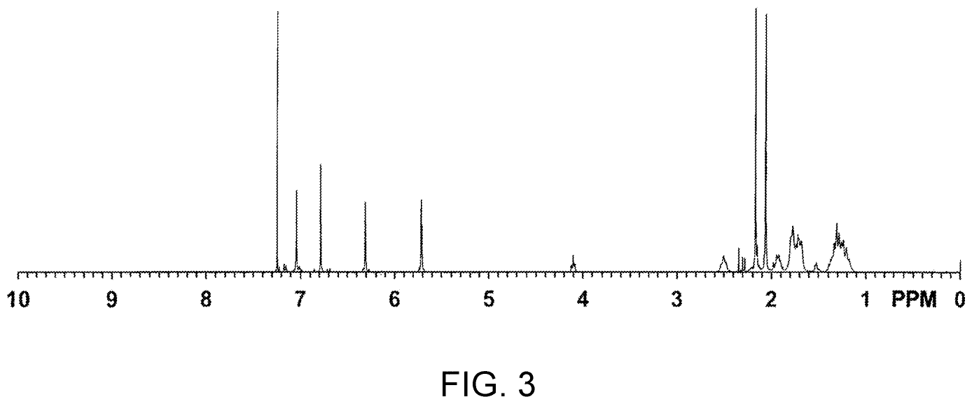

Through this ¹H-NMR measurement, the synthesis of curable resins obtained by the methods below was confirmed based on the disappearance of the peak for aldehyde (see FIG. 1 for Example 1, FIG. 2 for Example 9, and FIG. 3 for Example 10). It should be noted that in the Examples and Comparative Examples other than Examples 1, 9, and 10, too, the synthesis of a curable resin was confirmed in the same manner through this ¹H-NMR measurement (not illustrated).

### <Measurement of the Hydroxyl Group Concentration>

The hydroxyl number was measured by a method according to JIS K 1557-1, and the hydroxyl group concentration (mmol/kg) was calculated according to the formula of 1000× hydroxyl number/56.11.

### Example 1

A 200-mL three-necked flask equipped with a condenser was charged with 67.19 g (0.55 mol) of 2,6-xylenol and 56.19 g of 96% sulfuric acid, and the xylenol and sulfuric acid were dissolved in 30 mL of methanol under a nitrogen flow. The solution was warmed in an oil bath at 70° C., 25.03 g (0.125 mol) of a 50% aqueous solution of glutaraldehyde was added over 6 hours with stirring, and then the mixture was allowed to react for 12 hours with stirring. After the end of the reaction, the resulting reaction mixture was cooled to room temperature, and 200 mL of toluene was added, and then washed with 200 mL of water. Then the organic layer was poured into 500 mL of hexane, and the solid that separated out was isolated by filtration and vacuum-dried, giving 21.56 g (0.039 mol) of an intermediate phenolic compound.

Twenty grams of toluene and 32.17 g (0.039 mol) of the intermediate phenolic compound were mixed into a 200-mL flask fitted with a thermometer, a condenser, and a stirrer, and heated to 110° C. Then 1.95 g (0.016 mol) of dimethylaminopyridine was added. At complete dissolution of the solids, 24.02 g (0.1558 mol) of methacrylic anhydride was added gradually. The resulting solution was maintained at 110° C. for 20 hours with continuous mixing. Then the solution was cooled to room temperature and added dropwise into 360 g of hexane over 30 minutes, with the hexane stirred vigorously with a magnetic stirrer in a 1-L beaker. The resulting precipitate was filtered under reduced pressure and then dried, giving 32.18 g (0.039 mol) of a curable resin.

Based on ¹H-NMR measurement (see FIG. 1) and hydroxyl number measurement, the resin was considered a structure primarily being the structural formula below (for the methacryloyl groups in the structural formula below, a subset of the hydroxyl groups may have failed to react with the methacrylic anhydride and remain a hydroxyl group or groups) and having a hydroxyl group concentration of 0.01 mmol/kg.

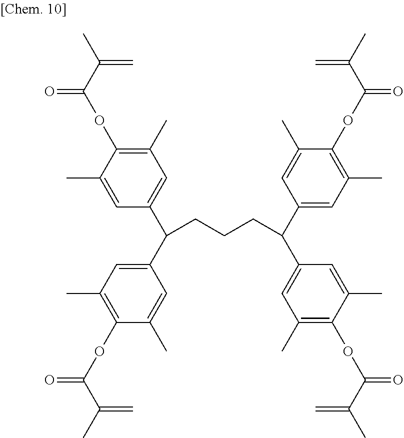 [SMILES: C=C(C)C(=O)Oc1c(C)cc(C(CCCC(c2cc(C)c(OC(=O)C(=C)C)c(C)c2)c2cc(C)c(OC(=O)C(=C)C)c(C)c2)c2cc(C)c(OC(=O)C(=C)C)c(C)c2)cc1C]

### Example 2

Synthesis was carried out in the same manner as in Example 1 above, except that the methacrylic anhydride in Example 1 was changed to 23.98 g (0.1555 mol). This gave a curable resin primarily being the same structure as in Example 1 and having a hydroxyl group concentration of 0.1 mmol/kg.

### Example 3

Synthesis was carried out in the same manner as in Example 1 above, except that the methacrylic anhydride in Example 1 was changed to 23.93 g (0.1552 mol). This gave a curable resin primarily being the same structure as in Example 1 and having a hydroxyl group concentration of 1 mmol/kg.

### Example 4

Synthesis was carried out in the same manner as in Example 1 above, except that the methacrylic anhydride in Example 1 was changed to 23.81 g (0.1544 mol). This gave a curable resin primarily being the same structure as in Example 1 and having a hydroxyl group concentration of 10 mmol/kg.

### Example 5

Synthesis was carried out in the same manner as in Example 1 above, except that the methacrylic anhydride in Example 1 was changed to 23.57 g (0.1529 mol). This gave a curable resin primarily being the same structure as in Example 1 and having a hydroxyl group concentration of 110 mmol/kg.

### Example 6

Synthesis was carried out in the same manner as in Example 1 above, except that the methacrylic anhydride in Example 1 was changed to 19.24 g (0.1248 mol). This gave a curable resin primarily being the same structure as in Example 1 and having a hydroxyl group concentration of 1000 mmol/kg.

### Example 7

Synthesis was carried out in the same manner as in Example 1 above, except that the methacrylic anhydride in Example 1 was changed to 17.07 g (0.1108 mol). This gave a curable resin primarily being the same structure as in Example 1 and having a hydroxyl group concentration of 1510 mmol/kg.

### Example 8

Synthesis was carried out in the same manner as in Example 1 above, except that the methacrylic anhydride in Example 1 was changed to 12.02 g (0.0780 mol). This gave a curable resin primarily being the same structure as in Example 1 and having a hydroxyl group concentration of 2950 mmol/kg.

### Example 9

A 200-mL three-necked flask equipped with a condenser was charged with 67.19 g (0.55 mol) of 2,6-xylenol and 56.19 g of 96% sulfuric acid, and the xylenol and sulfuric acid were dissolved in 30 mL of methanol under a nitrogen flow.

The solution was warmed in an oil bath at 70° C., 25.03 g (0.125 mol) of a 50% aqueous solution of glutaraldehyde was added over 6 hours with stirring, and then the mixture was allowed to react for 12 hours with stirring. After the end of the reaction, the resulting reaction mixture was cooled to room temperature, and 200 mL of toluene was added, and then washed with 200 mL of water. Then the organic layer was poured into 500 mL of hexane, and the solid that separated out was isolated by filtration and vacuum-dried, giving 21.56 g (0.039 mol) of an intermediate phenolic compound.

To a 300-mL flask fitted with a thermometer, a condenser, and a stirrer were added 21.56 g (0.039 mol) of the resulting intermediate phenolic compound, 0.046 g (0.00025 mol) of 2,4-dinitrophenol (2,4-DNP), 5.9 g (0.018 mol) of tetrabutylammonium bromide (TBAB), 23.56 g (0.1544 mol) of chloromethylstyrene, and 100 g of methyl ethyl ketone. The ingredients were heated to 75° C. with stirring.

Then a 48%-NaOHaq was added dropwise over 20 minutes to the reaction vessel kept at 75° C. After the end of the dropwise addition, stirring was continued for 20 h at 75° C. After 20 h, the mixture was cooled to room temperature, 100 g of toluene was added, and then the mixture was neutralized by adding 10% HCl. Then the aqueous phase was isolated by separation and washed with 300 mL of water and separated three times. The resulting organic phase was concentrated by distillation, and the product was reprecipitated by adding methanol. The precipitate was filtered and dried, giving 39.68 g (0.039 mol) of a curable resin.

Based on ¹H-NMR measurement (see FIG. 2) and hydroxyl number measurement, the resin was considered a structure primarily being the structural formula below (for the vinylbenzyl ether groups in the structural formula below, a subset of the hydroxyl groups may have failed to react with the chloromethylstyrene and remain a hydroxyl group or groups) and having a hydroxyl group concentration of 9 mmol/kg.

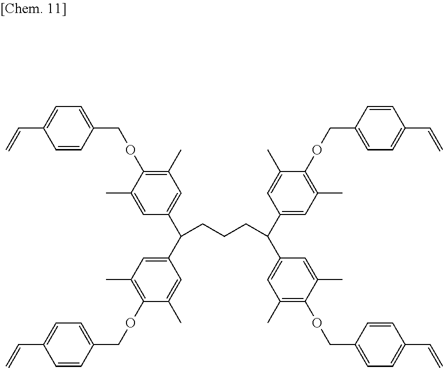 [SMILES: C=Cc1ccc(COc2c(C)cc(C(CCCC(c3cc(C)c(OCc4ccc(C=C)cc4)c(C)c3)c3cc(C)c(OCc4ccc(C=C)cc4)c(C)c3)c3cc(C)c(OCc4ccc(C=C)cc4)c(C)c3)cc2C)cc1]

### Example 10

A 200-mL three-necked flask equipped with a condenser was charged with 104.66 g (0.55 mol) of 2-cyclohexyl-5-methylphenol and 56.19 g of 96% sulfuric acid, and the phenol and sulfuric acid were dissolved in 30 mL of methanol under a nitrogen flow. The solution was warmed in an oil bath at 70° C., 25.03 g (0.125 mol) of a 50% aqueous solution of glutaraldehyde was added over 6 hours with stirring, and then the mixture was allowed to react for 12 hours with stirring. After the end of the reaction, the resulting reaction mixture was cooled to room temperature, and 200 mL of toluene was added, and then washed with 200 mL of water. Then the organic layer was poured into 500 mL of hexane, and the solid that separated out was isolated by filtration and vacuum-dried, giving 32.18 g (0.039 mol) of an intermediate phenolic compound.

Twenty grams of toluene and 32.18 g (0.039 mol) of the intermediate phenolic compound were mixed into a 200-mL flask fitted with a thermometer, a condenser, and a stirrer, and heated to 110° C.

Then 1.95 g (0.016 mol) of dimethylaminopyridine was added. At complete dissolution of the solids, 23.81 g (0.1544 mol) of methacrylic anhydride was added gradually. The resulting solution was maintained at 110° C. for 20 hours with continuous mixing.

Then the resulting solution was cooled to room temperature and added dropwise into 360 g of hexane over 30 minutes, with the hexane stirred vigorously with a magnetic stirrer in a 1-L beaker, yielding a precipitate. The resulting precipitate was filtered under reduced pressure and then dried, giving 42.80 g (0.039 mol) of a curable resin.

Based on ¹H-NMR measurement (see FIG. 3) and hydroxyl number measurement, the resin was considered a structure primarily being the structural formula below (for the methacryloyl groups in the structural formula below, a subset of the hydroxyl groups may have failed to react with the methacrylic anhydride and remain a hydroxyl group or groups) and having a hydroxyl group concentration of 11 mmol/kg.

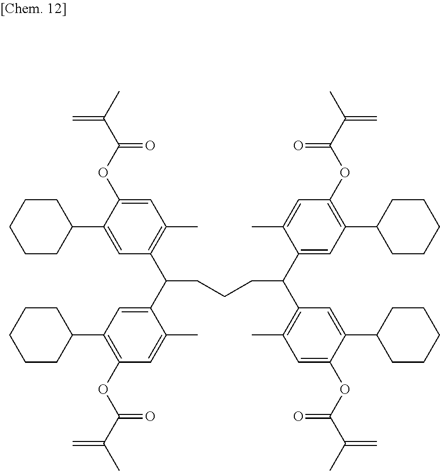 [SMILES: C=C(C)C(=O)Oc1cc(C)c(C(CCCC(c2cc(C3CCCCC3)c(OC(=O)C(=C)C)cc2C)c2cc(C3CCCCC3)c(OC(=O)C(=C)C)cc2C)c2cc(C3CCCCC3)c(OC(=O)C(=C)C)cc2C)cc1C1CCCCC1]

### Comparative Example 1

Synthesis was carried out in the same manner as in Example 1 above, except that the methacrylic anhydride in Example 1 was changed to 30.6 g (0.25 mol). This gave a curable resin primarily being the same structure as in Example 1 and having a hydroxyl group concentration of 0 mmol/kg.

### Comparative Example 2

Synthesis was carried out in the same manner as in Example 1 above, except that the methacrylic anhydride in Example 1 was changed to 8.42 g (0.0546 mol). This gave a curable resin primarily being the same structure as in Example 1 and having a hydroxyl group concentration of 4040 mmol/kg.

### Comparative Example 3

Ten parts by mass of the curable resin obtained in Comparative Example 1 and 0.0013 parts by mass of 4-methoxyphenol were mixed together to give a curable resin (mixture) having a hydroxyl group concentration of 10 mmol/kg.

### <Evaluation of Storage Stability>

A resin solution having a solids concentration of 80% was prepared by dissolving the curable resin in toluene. Using Toki Sangyo's RE100L viscometer, the initial viscosity and viscosity after 1 month of storage at 60° C. were measured at 25° C. Storage stability was evaluated based on the percentage change in viscosity (%) (100×(viscosity after 1 month at 60° C.−viscosity before storage)/viscosity before storage). It should be noted that when the storage stability was ∘ or Δ (the percentage viscosity change was less than 20%), the resin was considered acceptable for practical use.

### (Evaluation Criteria)

∘: Resins with a percentage change in viscosity of less than 10%
Δ: Resins with a percentage change in viscosity of 10% or more and less than 20%
x: Resins with a percentage change in viscosity of 20% or more

### <Preparation of Resin Films (Cured Products)>

The curable resins obtained in the Examples and Comparative Examples were mixed with 5 parts by mass, per 100 parts by mass of the curable resin, of α,α′-bis(t-butylperoxy)diisopropylbenzene as a radical polymerization initiator. The resulting curable resin compositions were put into a 5-cm square mold box, sandwiched between stainless steel plates, and set in a vacuum press. The pressure was increased to 1.5 MPa at atmospheric pressure and room temperature. After the pressure was reduced to 10 torr, the workpiece was warmed to 100° C. over 30 minutes and allowed to stand for 1 hour. Then the workpiece was warmed to 220° C. over 30 minutes and allowed to stand for 2 hours. Then the workpiece was cooled slowly to room temperature. In this manner, uniform resin films (cured products) having an average thickness of 100 μm were produced.

### <Evaluation of Heat Resistance (Glass Transition Temperature)>

The resulting resin films (cured products) were analyzed using PerkinElmer's DSC (Pyris Diamond) under the heating condition of 20° C./minute from room temperature. After the peak exothermic temperature (thermosetting temperature) was observed, the resin film was held at a temperature 50° C. higher than it for 30 minutes. Then the sample was cooled to room temperature under the cooling condition of 20° C./minute and then heated under the heating condition of 20° C./minute again, and the glass transition temperature (Tg) (° C.) of the resin film (cured product) was measured. It should be noted that the glass transition temperature (Tg) is practically acceptable when it is 100° C. or above, preferably is 150° C. or above.

### <Evaluation of Dielectric Properties>

For the in-plane dielectric properties of the resulting resin film (cured product), the dielectric constant and dielectric loss tangent at a frequency of 10 GHz were measured by the split post dielectric resonator method using Keysight Technologies' N5247A network analyzer. The dielectric loss tangent is practically acceptable when it is 10.0×10⁻³ or less, preferably is 3.0×10⁻³ or less, more preferably 2.5×10⁻³ or less. The dielectric constant is practically acceptable when it is 3.0 or less. Preferably, it is preferred that the dielectric constant be 2.7 or less, more preferably 2.5 or less.

TABLE 1

| | | | | | | | | | | | Comparative | | |
|---|---|---|---|---|---|---|---|---|---|---|---|---|---|
| | Examples | | | | | | | | | | Examples | | |
| | 1 | 2 | 3 | 4 | 5 | 6 | 7 | 8 | 9 | 10 | 1 | 2 | 3 |
| Hydroxyl group | 0.01 | 0.1 | 1 | 10 | 110 | 1000 | 1510 | 2950 | 19 | 11 | 0 | 4040 | 10 |
| concentration | | | | | | | | | | | | | |
| (mmol/kg) | | | | | | | | | | | | | |
| Dielectric loss | 2.0 | 2.0 | 2.1 | 2.0 | 2.2 | 2.3 | 2.3 | 2.6 | 3.0 | 2.6 | 2.0 | 3.1 | 2.4 |
| tangent (×10⁻³) | | | | | | | | | | | | | |
| Dielectric constant | 2.3 | 2.3 | 2.3 | 2.3 | 2.3 | 2.3 | 2.4 | 2.6 | 2.5 | 2.5 | 2.3 | 2.8 | 2.5 |
| Glass transition | 198 | 200 | 198 | 199 | 198 | 195 | 195 | 180 | 190 | 195 | 198 | 98 | 195 |
| temperature (Tg) | | | | | | | | | | | | | |
| (° C.) | | | | | | | | | | | | | |
| Storage stability | ∘ | ∘ | ∘ | ∘ | ∘ | ∘ | ∘ | ∘ | ∘ | ∘ | x | ∘ | x |

The evaluation results in Table 1 above confirmed that in the Examples, a solution of the curable resin was superior in storage stability, and a cured product obtained using the curable resin combined heat resistance with low dielectric properties. The heat resistance and the dielectric properties were practically acceptable levels.

The evaluation results in Table 1 above confirmed that in Comparative Example 1, by contrast, the storage stability of a resin solution prepared by dissolving the curable resin in toluene was inferior due to increased reactivity of the curable resin itself caused by a hydroxyl group concentration of the curable resin used that fell below the desired range. In Comparative Example 2, the hydroxyl group concentration of the curable resin used was above the desired range.

The proportion of non-hydroxyl crosslinking groups in the curable resin was low, causing the crosslink density of a cured product obtained using the curable resin to be low. The glass transition temperature was thus low, heat resistance was inferior, and, furthermore, the dielectric properties were also high compared with those in the Examples. In Comparative Example 3, moreover, the curable resin mixture prepared by mixing a curable resin having a hydroxyl group concentration below the desired range with 4-methoxyphenol had an overall hydroxyl group concentration inside the desired range. In the evaluation of a solution of the mixture, however, the overall storage stability of the mixture solution was inferior due to increased reactivity of the curable resin itself caused by a curable resin having a hydroxyl group concentration below the desired range, confirming the importance of adjusting the hydroxyl group concentration of the curable resin to the desired range.

### INDUSTRIAL APPLICABILITY

The curable resin according to the present invention is superior in storage stability, and a cured product obtained using this curable resin is superior in heat resistance and dielectric properties. Suitable applications, therefore, include heat-resistant components and electronic components. Particularly suitable applications include components such as prepregs, semiconductor encapsulants, circuit boards, build-up films, and build-up substrates as well as adhesives and resist materials. A matrix resin in fiber-reinforced plastics is also a suitable application, and another suitable application is highly heat-resistant prepregs.

1. A curable resin represented by general formula (1) below, wherein a hydroxyl group concentration is from 0.005 to 3800 mmol/kg, 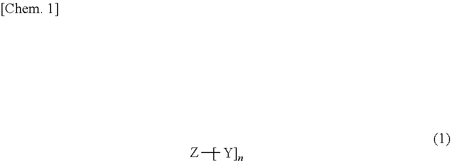
in the formula (1), Z is a C2 to C15 hydrocarbon; n denotes an integer of 3 to 5; Y is a substituent represented by general formula (2) below: 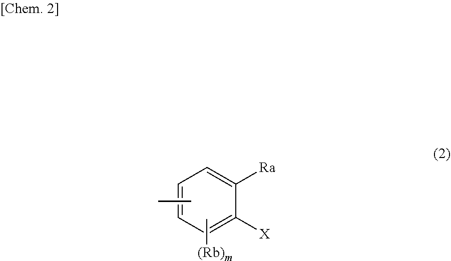
in the formula (2), Ra and Rb each independently represent an alkyl group, an aryl group, an aralkyl group, or a cycloalkyl group having a C12 or less; m denotes an integer of 0 to 3; X represents a hydroxyl, (meth)acryloyloxy, vinylbenzyl ether, or allyl ether group.

2. The curable resin according to claim 1, wherein the hydroxyl group concentration is from 0.01 to 1500 mmol/kg.

3. The curable resin according to claim 1, wherein the X is a methacryloyloxy group.

4. The curable resin according to claim 1, wherein the Z is an aliphatic hydrocarbon.

5. A curable resin composition comprising the curable resin according to claim 1.

6. A cured product obtained through a curing reaction of the curable resin composition according to claim 5.
